(19) United States
(12) Patent Application Publication
(10) Pub. No.: US 2006/0000287 A1
(43) Pub. Date: Jan. 5, 2006

(54) Apparatus for producing hydrogen

(75) Inventors: Ryoichi Arai, Kanagawa-ken (JP); Michio Sato, Kanagawa-ken (JP); Kazumi Watanabe, Tokyo (JP); Toru Onodera, Kanagawa-ken (JP); Ryota Takahashi, Tokyo (JP); Masaru Fukuie, Kanagawa-ken (JP)

Correspondence Address: FOLEY AND LARDNER LLP;SUITE 500, 3000 K STREET NW, WASHINGTON, DC, 20007, US

(73) Assignee: KABUSHIKI KAISHA TOSHIBA

(21) Appl. No.: 11/169,653

(22) Filed: Jun. 30, 2005

(30) Foreign Application Priority Data
Jun. 30, 2004 (JP) 2004-194618

(51) Int. Cl. G01L 11/00

(52) U.S. Cl. 73/703

(57) ABSTRACT

An apparatus for producing hydrogen is able to measure a position of a interface or a surface boundary of liquids in a reaction vessel without direct contact. An apparatus for producing hydrogen by an IS process includes a reaction vessel, a first ultrasonic probe and a second ultrasonic probe. Reacting liquids are introduced to the reaction vessel. The first ultrasonic probe is provided at the bottom of the reaction vessel to detect a position of a boundary surface of the reacting liquids. The second ultrasonic probe is provided at the side wall of the reaction vessel to compensate the sound velocity.

### CROSS REFERENCE TO RELATED APPLICATION

This application is based upon and claims the benefit of priority from prior Japanese Patent Application No. 2004-194618 filed on Jun. 30, 2004, the entire contents of which are incorporated herein by reference.

### FIELD OF THE INVENTION

This invention relates to an apparatus for producing hydrogen continuously, and in particular, an apparatus for producing hydrogen by using IS (Iodine-Sulfur) process that can precisely measure a position of a boundary surface of multilayer liquids, constituent and concentration of the liquids in a reaction vessel.

### DESCRIPTION OF THE BACKGROUND

Hydrogen is being spotlighted as one option for clean energy in the next generation. As many investigations for utilizing hydrogen as an energy source such as a fuel cell are studied, investigations for producing hydrogen as a fuel are also being made.

With regard to a hydrogen producing process, it is known that a process of thermochemical decomposition of water (also referred to as an “IS process”) can produce hydrogen continuously. The IS process can be operated by utilizing heat of, for example, a high-temperature gas-cooled reactor.

For the IS process operation by utilizing heat of a high-temperature gas-cooled reactor, a basic concept or a configuration for an apparatus is being investigated. However, sufficient study necessary for operating the apparatus, such as a technology for measurement or an operation control technology, has not been investigated yet.

When producing hydrogen by using the IS process, it is necessary to keep the ratio of amount of hydrogen and oxygen, which are produced in the apparatus, at a 2:1 value, and it is also necessary to keep the constituent of processed solutions before and after the process the same. Therefore, it is needed to develop a method for controlling and operating for the IS process which meets the above two necessites during the process. For the IS process, a solution of hydriodic acid (also referred to as HI) and a solution of sulfuric acid (also referred to H₂SO₄) are generated in a reaction vessel. Thus, it is necessary to develop a non-contact liquid level measuring apparatus that can measure the generation ratios of the hydriodic acid solution and the sulfuric acid solution, or that can measure the constituents or concentrations of these solutions in the reaction vessel.

Related to these technologies, Japanese patent publication (Kokai) No. 8-14990 discloses a liquid level measuring apparatus that utilizes ultrasonic waves to detect the level of oil in an airtight container of power equipment which high voltage is applied to. This apparatus enables to detect infiltrations of rainwater into the airtight container or leak of oil from the container. Further, Japanese patent publication (Kokai) No. 4-33620 discloses an apparatus that can detect a boundary between two non-mixing liquids in a tank by utilizing ultrasonic waves. These non-contact liquid level measurement techniques are intended to detect a level or a surface boundary of a liquid that is enclosed and is stable in the container or the tank.

On the other hand, in the reaction vessel of a hydrogen producing apparatus using the IS process, water (H₂O), Iodine (I₂) and sulfur dioxide (SO₂) are reacted and providing hydriodic acid (HI) and sulfuric acid (H₂SO₄). This reaction is referred to as a “Bunsen reaction”. To produce hydrogen continuously, it is necessary to estimate the amount of HI and H₂SO₄ precisely in the operation for producing hydrogen in the IS process.

### SUMMARY OF THE INVENTION

Accordingly, an advantage of an aspect of the present invention is to provide an apparatus for producing hydrogen that is able to measure a position of a interface or a surface boundary of liquids in a reaction vessel without contact.

To achieve the above advantage, one aspect of the present invention is to provide an apparatus for producing hydrogen by IS process that comprises a reaction vessel where reacting liquids are to be introduced, a first ultrasonic probe provided at the bottom of the reaction vessel to detect a position of a boundary surface of the reacting liquids, and a second ultrasonic probe, provided at the side wall of the reaction vessel to compensate the sound velocity.

Another aspect of the patent invention is to provide an apparatus for producing hydrogen by IS process that comprises a reaction vessel, in which reacting liquids are to be introduced, an ultrasonic transmission probe provided at a first side wall of the reaction vessel, an ultrasonic receiving probe provided at a second side wall which faces to the first side wall where the first ultrasonic probe is provided, an ultrasonic transmitter connected to the ultrasonic transmission probe, an ultrasonic receiver connected to the ultrasonic receiving probe, and a data processing unit connected to the ultrasonic transmitter and the ultrasonic receiver, which calculates a position of a boundary surface of the reacting liquid inside the reaction vessel.

Further features, aspects and advantages of the present invention will become apparent from the detailed description of preferred embodiments that follows, when considered together with the accompanying figures.

### BRIEF DESCRIPTION OF THE DRAWINGS

FIG. 1 is a schematic drawing showing a principle of an IS process.

FIG. 2 is a schematic sectional view of an apparatus for producing hydrogen by IS process in accordance with the first embodiment.

FIG. 3 shows a schematic graph of observed ultrasonic pulses transmitted or received from the ultrasonic probe used in the first embodiment.

FIG. 4 is a schematic sectional view of a modification of the first embodiment.

FIG. 5 is a schematic sectional view of a further modification of the first embodiment.

FIG. 6 is a schematic sectional view of another modification of the first embodiment.

FIG. 7 is a schematic sectional view of an apparatus for producing hydrogen by IS process in accordance with the second embodiment.

FIG. 8 is a schematic sectional view of a modification of the second embodiment.

FIGS. 9 and 10 are schematic sectional views of another modification of the second embodiment.

FIG. 11 is a schematic sectional view of an apparatus for producing hydrogen by IS process in accordance with the third embodiment.

FIG. 12 is a schematic sectional view of an apparatus for producing hydrogen by IS process in accordance with the forth embodiment.

FIG. 13 is a schematic sectional view of an apparatus for producing hydrogen by IS process in accordance with the fifth embodiment.

FIG. 14 is a schematic sectional view of an apparatus for producing hydrogen by IS process in accordance with the sixth embodiment.

FIG. 15 is a graph showing the relations between neutron energy and a neutron reaction cross section or a neutron absorption cross section of sulfur.

FIG. 16 is a graph showing the relations between neutron energy and a neutron reaction cross section or a neutron absorption cross section of iodine.

### DETAILED DESCRIPTION OF THE PREFERRED EMBODIMENTS

The preferred embodiments in accordance with the present invention are described below with reference to the drawings.

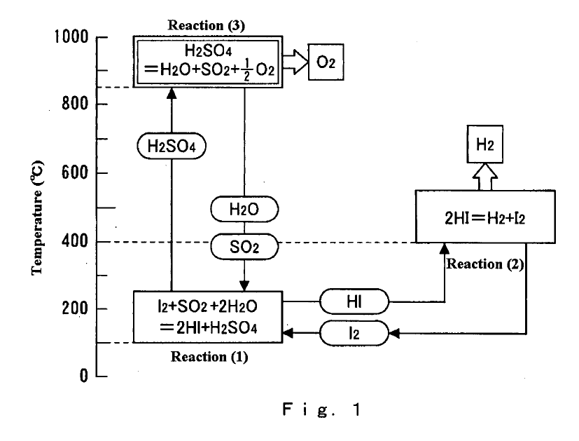

FIG. 1 is a schematic drawing showing a principle of an IS process, which is a process of thermochemical decomposition of water used in the embodiments. It is known that the IS process according to FIG. 1 can produce hydrogen continuously.

It is generally known that hydrogen can be produced inexhaustibly from water and that hydrogen is an emission-free “clean” fuel because it becomes water after it is used as a fuel. It is regarded that hydrogen may be an alternative for fuel used for a home, an industrial site, a vehicle, or an aircraft since it is also relatively easy to store.

To produce hydrogen by a high-temperature gas-cooled reactor, an IS process is known that does not utilize electric decomposition of high temperature steam, or steam reforming of coal or natural gas.

The IS process comprises several stages of reactions which apply substances other than water, wherein heat necessary for those reactions can be given from the high-temperature gas-cooled reactor. Generally, the high-temperature gas-cooled reactor can supply heat at about 1,000 degrees centigrade. Thus, the IS process coupled with the high-temperature gas-cooled reactor can easily utilize heat necessary for the reactions.

In the IS process, water (H₂O), sulfur dioxide (SO₂) and iodine (I₂) are reacted to generate hydriodic acid (HI) and sulfuric acid (H₂SO₄) for the first step. The reaction formula of this reaction is described as below.
2H₂O+SO₂+I₂=2HI+H₂SO₄ (1)

This reaction, which is referred to as a “Bunsen reaction”, is an exothermic reaction that occurs in a condition of temperature that is from room temperature to about 100 degrees centigrade.

By the reaction (1), HI and H₂SO₄ are obtained in a reaction vessel, which will be described later. Because HI and H₂SO₄ are non-mixing liquids that do not mix with each other, hydriodic acid and sulfuric acid are obtained as they form two layers in the reaction vessel by difference of their respective density.

Hydrogen can be produced by a thermal decomposition of hydriodic acid produced by the Bunsen reaction (1). The thermal decomposition of the hydriodic acid occurs at about 400 degrees centigrade. This reaction is described as below.
2HI═H₂+I₂ (2)

While hydrogen is obtained by the reaction (2), a solution of sulfuric acid produced by the Bunsen reaction (1) is decomposed to oxygen, water, and sulfur dioxide by a thermal decomposition reaction that occurs at about 800 degrees centigrade or higher. This thermal decomposition reaction of sulfuric acid is endothermic reaction. The reaction formula is described as below.

$${H}_{2} {SO}_{4} = {SO}_{2} + {H}_{2} O + \frac{1}{2} {O}_{2} \qquad ( 3 )$$

Water (H₂O) and sulfur dioxide (SO₂) obtained by decomposition reaction of the sulfuric acid (3) are utilized in the Bunsen reaction (1) together with the iodine (I₂) obtained by decomposition reaction of hydriodic acid (2).

As described above, sulfur dioxide and iodine, which are necessary to produce hydrogen in the IS process, are repeatedly used in the reactions of the IS process. Further, because other substances that are produced in the IS process are water and oxygen, the IS process is regarded as a clean closed-loop process to produce hydrogen continuously.

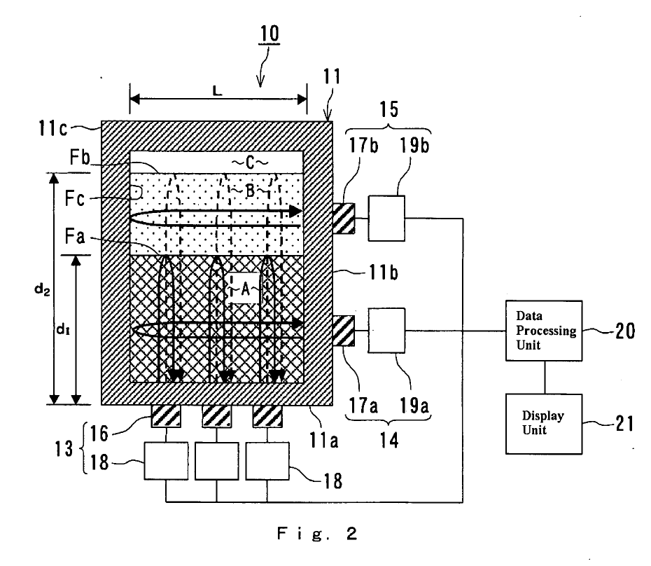

FIG. 2 is a schematic sectional view of an apparatus for producing hydrogen by IS process in accordance with the first embodiment of the present invention.

A hydrogen production apparatus 10 can precisely measure a surface boundary Fa or Fb such as a boundary surface between two reacting liquids existing in a reaction vessel 11 without contact.

Reaction vessel 11 of the hydrogen producing apparatus 10 encloses hydriodic acid (HI) solution A and sulfuric acid (H₂SO₄) solution B resulted from the Bunsen reaction. Hydriodic acid (HI) solution A and sulfuric acid (H₂SO₄) solution B are both in a liquid state, as reacting liquids.

Since HI solution A and H₂SO₄ solution B (also referred to as reacting liquids) are non-mixing liquids with each other, they are separately held in the reaction vessel 11, wherein the H₂SO₄ solution B, which has lower density than HI solution A, is disposed above the HI solution B. In the space above the H₂SO₄ solution B in the reaction vessel 11, gas C produced in the reaction vessel 11, such as oxygen or hydrogen may exist.

Reaction vessel 11 has a box-shaped (e.g., rectangular) enclosure. The reaction vessel 11 includes at least one ultrasonic transducer 13 at a bottom 11a of the reaction vessel 11. The reaction vessel 11 shown in FIG. 2 includes three ultrasonic transducers 13 at the outside surface of the bottom 11a. Here, the ultrasonic transducer 13 is defined as the ultrasonic prove and ultrasonic transmitter and receiver.

The ultrasonic transducer 13 may be in the bottom 11a of the reaction vessel 11. Reaction vessel 11 further includes a plurality of ultrasonic transducers 14, 15 at a side wall 11b of the reaction vessel 11. One of the ultrasonic transducers 14, 15 is located at a lower side of the side wall lib, while the other is located at an upper side of the side wall 11b. Each of the ultrasonic transducers 13, 14 or 15 includes a ultrasonic probe 16, 17a or 17b, and an ultrasonic transmitter/receiver 18, 19a or 19b coupled with these ultrasonic probe 16, 17a or 17b, respectively. The ultrasonic probe 16, 17a or 17b is able to transmit or receive an ultrasonic waves of a predetermined frequency coupled with the ultrasonic transmitter/receiver 18, 19a or 19b.

When the ultrasonic transducer 13, 14 or 15 generates an electric pulse to the ultrasonic probe 16, 17a or 17b, an ultrasonic wave, which has for example a frequency of 5 MHz, is transmitted from the ultrasonic probe 16, 17a or 17b inside the reaction vessel 11.

The ultrasonic waves transmitted inside the reaction vessel 11 reflect at a liquid-liquid boundary surface Fa, a gas-liquid boundary surface Fb or a solid-liquid boundary surface Fc due to the difference of the density at the locations. These reflected ultrasonic waves are referred to as reflected echoes. The ultrasonic probe 16, 17a or 17b is also able to detect the reflected echoes. The reflected echoes are received and converted to an echo electric signal by the transmitter/receiver 18, 19a or 19b. The echo electric signal is sent to a data processing unit 20. The data processing unit 20 processes the echo electric signal and calculates positions (height) of the liquid-liquid boundary surface Fa and the gas-liquid boundary surface Fb in the reaction vessel 11 without contact. Results of the calculation are outputted on a display unit 21.

The ultrasonic transducer 13, which is provided at the bottom 11a of the reaction vessel, is used to detect the liquid-liquid boundary surface Fa and the gas-liquid boundary surface Fb in the reaction vessel 11. FIG. 2 shows a configuration that has three ultrasonic transducers 13 to detect the liquid-liquid boundary surface Fa and the gas-liquid boundary surface Fb. The ultrasonic transducer 14, which is provided at a lower side of the side wall 11b, is for compensation of the sound velocity used for the HI solution A existing as a lower layer in the reaction vessel 11. The ultrasonic transducer 15, which is provided at a upper side of the side wall 11b, is also for compensation of the sound velocity. However, the ultrasonic transducer 15 is used to compensate the sound velocity in the H₂SO₄ solution B, which separately exists as an upper layer in the reaction vessel 11.

An ultrasonic pulse of the ultrasonic waves transmitted from the ultrasonic probe 16, by the operation of the ultrasonic transducer 13, penetrates through the bottom 11a of the reaction vessel 11 and goes upwardly in the HI solution A in the reaction vessel 11.

A part of the ultrasonic pulse transmitted in the reaction vessel 11 which reaches at the liquid-liquid boundary surface Fa is reflected downwardly as reflected echoes due to the difference of the acoustic impedance between HI solution A and H₂SO₄ solution B, which is resulted from the difference of densities and velocity of those solutions. The reflected echoes then come back to the ultrasonic probe 16 through the bottom 11a.

The other part of the ultrasonic pulse transmitted in the reaction vessel 11, which penetrates through the liquid-liquid boundary surface Fa, further goes upwardly in the H₂SO₄ solution B. However this ultrasonic pulse is also reflected downwardly as the reflected echoes at the gas-liquid boundary surface Fb and comes back to the ultrasonic probe 16.

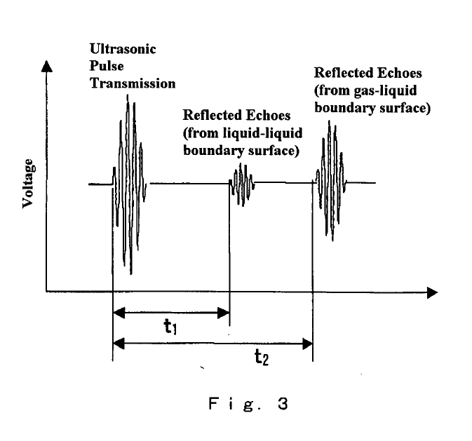

Because the difference of the acoustic impedance between the H₂SO₄ solution B and the gas C is greater than that between the solutions A and B, magnitude of the reflected echoes that come from the gas-liquid boundary surface Fb is also greater than the reflected echoes that comes from the liquid-liquid boundary surface Fa. FIG. 3 shows a schematic graph of observed ultrasonic pulses transmitted or received from the ultrasonic probe 16, which explains this situation.

As shown in FIG. 3, when the ultrasonic pulse is transmitted from the ultrasonic probe 16, two reflected echoes can be observed. First, lesser magnitude reflected echoes, which are reflected at the liquid-liquid boundary surface Fa, are observed at a time t1 from the transmission. Then, greater magnitude reflected echoes, which is reflected at the gas-liquid boundary surface Fb, are observed at a time t2 from the transmission (t2>t1).

The distance d1 from the outside surface of the bottom 11a to the liquid-liquid boundary surface Fa between the HI solution A and H₂SO₄ solution B in the reaction vessel can be obtained by the formula (4) using time t1 and the speed v1 of the ultrasonic waves in the HI solution A.

$${d}_{1} = \frac{{v}_{1} * {t}_{1}}{2} \qquad ( 4 )$$

The velocity v1 of the ultrasonic waves in the HI solution A can be measured by utilizing the ultrasonic probe 17a in the ultrasonic transducer 14, which is provided on the outer surface of the lower side of the side wall 11b of the reacting vessel 11. The ultrasonic probe 17a is provided as it can receive reflected ultrasonic waves at the inner surface of the side wall 11b of the opposite side of the ultrasonic transducer 14. The ultrasonic probe 17 is also provided at the lower side of the side wall 11b, where the HI solution A should exist in the reaction vessel 11. The distance of a propagation of the ultrasonic pulse inside the reaction vessel 11 is 2 L, because the ultrasonic pulse transmitted from the ultrasonic probe 17 reflects at an opposite side wall 11c and returns to the ultrasonic probe 17. This is based on an assumption that the width of the sidewall 11b is relatively small compared to the reaction vessel width L. When the width of the sidewall lib can not be neglected, it may be considered. Defining time between transmission and receive of the ultrasonic pulse at the ultrasonic probe 17a as T1, the velocity v1 of the ultrasonic waves in the HI solution A can be obtained by a formula (5).

$${v}_{1} = \frac{2 L}{{T}_{1}} \qquad ( 5 )$$

Therefore, the distance d1 from the outside surface of the bottom 11a to the liquid-liquid boundary surface Fa between the HI solution A and the H₂SO₄ solution B in the reaction vessel can be calculated by the formula (6).

$${d}_{1} = \frac{{v}_{1} \cdot {t}_{1}}{2} = \frac{L}{{T}_{1}} \cdot {t}_{1} \qquad ( 6 )$$

The same situation can be applied to the velocity v2 of the ultrasonic waves in the H₂SO₄ solution B. In this embodiment, the ultrasonic transducer 15 is provided on the outer surface of the upper side, where the H₂SO₄ solution B should exist in the reaction vessel 11, of the side wall 11b. Thus the ultrasonic probe 17b can receive reflected ultrasonic waves at the inner surface of the side wall 11b at the opposite side of the ultrasonic transducer 15. Since the distance of a propagation of the ultrasonic pulse inside the reaction vessel 11 is also 2 L, the velocity v2 of the ultrasonic waves in the H₂SO₄ solution B is obtained by a formula (7) when defining time between transmission and receive of the ultrasonic pulse at the ultrasonic probe 17b as T2.

$${v}_{2} = \frac{2 L}{{T}_{2}} \qquad ( 7 )$$

Therefore, the distance d2 from the outside surface of the bottom 11a to the gas-liquid boundary surface Fb between the H₂SO₄ solution B and the gas C in the reaction vessel can be calculated by the formula (8), by using observed time t2, which is the time taken to receive the reflected echoes from the liquid-gas boundary surface Fb after the transmission of the ultrasonic pulse from the ultrasonic probe 16, shown in FIG. 3.

$${d}_{2} = {d}_{1} + \frac{{v}_{2} ( {t}_{2} - {t}_{1} )}{2} = \frac{L}{{T}_{1}} {t}_{1} + \frac{L}{{T}_{2}} ( {t}_{2} - {t}_{1} ) \qquad ( 8 )$$

As explained above, the actual velocity v1, v2 of the ultrasonic wave propagating inside the solutions A and B (reacting liquids) in the reaction vessel 11 can be obtained from the observed data of the ultrasonic transducers 14, 15, which are provided at the side wall 11b of the reaction vessel 11. Therefore, the position of the liquid-liquid boundary surface Fa and the gas-liquid boundary surface Fb can be obtained precisely based on the time taken to receive the reflected echoes at the ultrasonic transducer 13, which is provided at the bottom 11b, regardless of the change of the propagation speed of the ultrasonic waves inside the solutions A or B due to the change of temperature or concentration.

In this embodiment, a plurality of ultrasonic transducers 13 may be provided at the bottom 11a of the reaction vessel 11 to increase the accuracy of the calculated position of the boundary surface Fa and Fb, such as in a case where the boundary surface Fa or Fb is in a rippling condition. The average if the values obtained by the plural ultrasonic transducers may be utilized, for example.

Further, instead of using ultrasonic probe 17a or 17b for both of transmission and receive of the ultrasonic waves by the ultrasonic transmitter/receiver 19a or 19b for compensation of the sound speed in the reacting liquid as described in this embodiment, a pair of ultrasonic probes may be provided at the side wall 11b and at the opposite side wall 11c. In such a case, one ultrasonic probe is used for transmission of the ultrasonic waves coupled with the ultrasonic transmitter, while the other is used for reception coupled with the ultrasonic receiver.

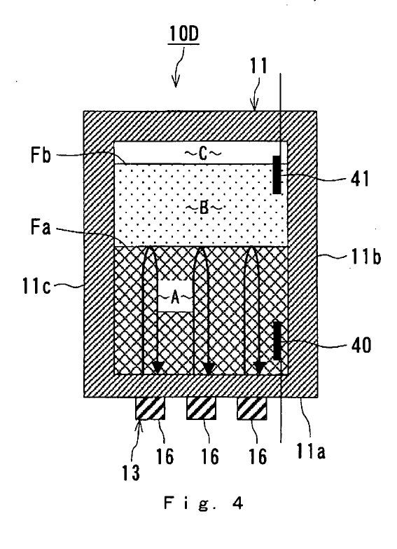

FIG. 4 is a schematic sectional view of a modification of the first embodiment of the apparatus for producing hydrogen by IS process. In FIG. 4, the same numeric symbols are used for the same elements as shown in FIG. 2. Detailed descriptions may be omitted for those elements.

As shown in FIG. 4, the reaction vessel 11 of the hydrogen production apparatus 10D according to the modification also comprises at least one ultrasonic transducer 13 provided at the bottom 11a of the reaction vessel 11. The hydrogen production apparatus 10D also comprises a set of thermometers 40, 41 in the reaction vessel 11. The thermometer 40 measures the temperature of the HI solution A existing in the lower side of the reaction vessel, while the other thermometer 41 measures the temperature of the H₂SO₄ solution B. The thermometer 40, 41 are preferably sealed because harmful substances are in the reaction vessel 11. The thermometer 40, 41 may be a sheathed thermocouple or a resistance temperature detector, for example.

The thermometers 40, 41 are connected to the data processing unit, which is not shown in FIG. 4 but is substantially the same as the data processing unit 20 shown in FIG. 2. Temperature data detected in the thermometers 40, 41 are sent to the data processing unit.

The ultrasonic transducer 13, which is provided at the bottom 11a of the reaction vessel 11, transmits a pulse of ultrasonic waves upwardly into the reaction vessel 11 to detect the position of the boundary surfaces such as the liquid-liquid boundary surface Fa and the gas-liquid boundary surface Fb in the same way as described in the first embodiment. In the other words, the position of the boundary surfaces Fa and Fb are also measured based upon the time difference between the transmission of the ultrasonic pulse and the receive of the reflected echo at the ultrasonic transducer 13 in this modification.

As mentioned in the first embodiment, however, it is necessary to compensate the sound velocity in the solutions A and B to measure the position of the boundary surfaces Fa and Fb precisely. In this modification, the temperature data detected by the thermometer 40, 41 are used for the compensations of the sound velocity in the solution A or B.

The function that correlates the sound velocity in the HI solution A or H₂SO₄ solution B with the temperature can be predetermined. Therefore these functions, the correlations between the temperature and the sound velocity in the reacting liquids, are stored in the data processing unit in advance.

Once the thermometer 40 or 41 detects the temperature data, the data processing unit can refer to the stored function and obtain the estimated sound speed in the solution A or B. Thus the sound speed in the solutions A and B is compensated, the position of the boundary surfaces Fa and Fb can be measured precisely based upon the time difference between the transmission of the ultrasonic pulse and the reception of the reflected echo at the ultrasonic transducer 13.

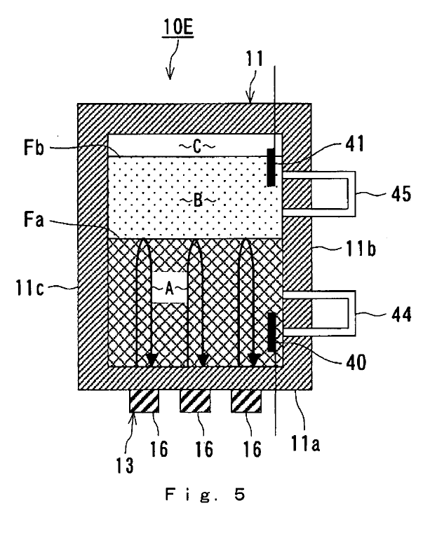

FIG. 5 is a schematic sectional view of a further modification of the modified embodiment shown in FIG. 4. In FIG. 5, the same numeric symbols are used for the same elements as shown in FIG. 2 and FIG. 4. Thus, detailed descriptions have been omitted for those elements.

As shown in FIG. 5, the reaction vessel 11 of a hydrogen production apparatus 10E according to this modification further comprises sampling lines 44 and 45 to the modification shown in FIG. 4. Other elements are substantially the same as the modification shown in FIG. 4.

The sampling lines 44, 45 are provided in the side wall 11b of the reaction vessel 11, separately in the vertical direction to each other. The sampling line 44 is provided at a lower side of the side wall 11b, where the HI solution A should exist in the reaction vessel 11. The sampling line 44 samples the HI solution A in the reaction vessel 11 and detects its concentration. On the other hand, the sampling line 45 is provided at an upper side of the side wall 11b, where the H₂SO₄ solution B should exist in the reaction vessel 11. The sampling line 45 samples the H₂SO₄ solution B and detects its concentration. The concentration data detected by the sampling line 44 and 45 are sent to the data processing unit.

In this modification, the concentration data detected by the sampling line 44, 45 are further used for the compensations of the sound speeds in the solution A or B, in addition to the compensation of the sound speed based upon the temperature of the solutions A or B.

The function that correlates the sound velocity in the HI solution A or the H₂SO₄ solution B with the concentration can be predetermined. Therefore these functions, the correlations between the concentration and the sound velocity in the reacting liquids, are stored in the data processing unit in advance together with the functions between the temperature and the sound velocity in the HI solution A and H₂SO₄ solution B.

Using the concentration data detected by the sampling line 44, 45, together with the temperature data detected by the thermometer 40 or 41, the data processing unit obtains the estimated sound velocity in the solution A or B by referring to the functions stored in the data processing unit. Thus, the sound velocity in the solutions A and B is compensated, the position of the boundary surfaces Fa and Fb can be measured more precisely based upon the time difference between the transmission of the ultrasonic pulse and the receive of the reflected echo at the ultrasonic transducer 13. Other devices, such as a device using ultrasonic waves or a device emitting radiation instead of the sampling line 44, 45, may detect the concentration data.

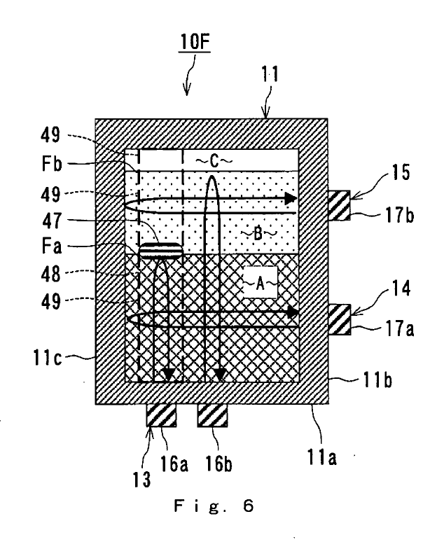

FIG. 6 is a schematic sectional view showing another modification of the first embodiment. In FIG. 6, the same numeric symbols are used for the same elements as shown in FIG. 2. Accordingly, detailed descriptions have been omitted for those elements.

A hydrogen production apparatus 10F further comprises a float 47, which reflects the ultrasonic waves, in the reaction vessel 11. The density of the float 47 is adjusted in between the density of the HI solution A and the H₂SO₄ solution B. Therefore, the float 47 floats on the liquid-liquid boundary surface Fa. The hydrogen production apparatus 10F further comprises a guide 48 that restricts the horizontal movement of the float 47. The guide 48 is preferably of a cylindrical shape, having holes 49 in the side wall of the cylinder that enables the solutions A and B to go inside of the guide 48 through the holes 49. The guide 48 may alternatively be a cylindrical net. The float 47 and the guide 48 are provided above the ultrasonic probe 16a that is provided at the bottom 11a of the reaction vessel 11. At least two ultrasonic probes 16a and 16b may be provided at the bottom 11a.

All the ultrasonic pulses transmitted from the ultrasonic probe 16a are reflected at the float 47 because the float 47 is a reflector of the ultrasonic waves. Therefore, the ultrasonic probe 16a can receive the reflected echo, which is reflected at the surface of the float 47, with a strong intensity. Thus, the ultrasonic probe 16a is used to detect the liquid-liquid boundary surface Fa.

On the other hand, a part of the ultrasonic pulse transmitted from the ultrasonic probe 16b goes through the liquid-liquid boundary surface Fa and is reflected at the surface of the gas-liquid boundary surface Fb. The ultrasonic probe 16b is used to detect the gas-liquid surface Fb.

This modification may be useful when multiple reflections of the ultrasonic waves occur at the liquid-liquid boundary surface Fa and the reflected echoes from the liquid-liquid boundary surface Fa cannot be received with enough intensity at the ultrasonic probe 16b.

The ultrasonic transducer 14 and 15, which are provided at the side wall 11b of the reaction vessel 11, compensate the sound velocity in the solution A and B in the same manner described in the first embodiment shown in FIG. 2. Devices shown in FIG. 4 or 5, such as thermometers 40, 41 or sampling lines 44, 45, may be used for compensation of the sound speed in the solution A and B.

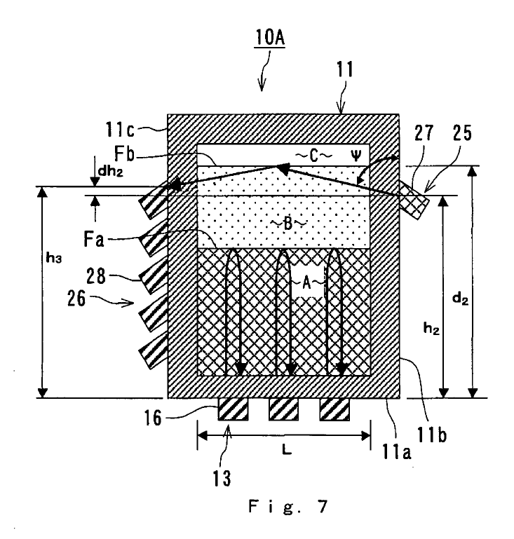

FIG. 7 is a schematic sectional view of an apparatus for producing hydrogen by IS process in accordance with the second embodiment. In FIG. 7, the same numeric symbols are used for the same elements as shown in FIG. 2. Accordingly detailed descriptions have been omitted for those elements.

A hydrogen production apparatus 10A can precisely measure a surface boundary Fa or Fb, such as a boundary surface between two reacting liquids existing in a reaction vessel 11, without contact.

Reaction vessel 11 of the hydrogen producing apparatus 10 encloses hydriodic acid (HI) solution A and sulfuric acid (H₂SO₄) solution B resulted from the Bunsen reaction. Hydriodic acid (HI) solution A and sulfuric acid (H_{2S}O₄) solution B are both in a liquid state, as reacting liquids.

Since HI solution A and H₂SO₄ solution B are non-mixing liquids that do not mix with each other, they are separately held in the reaction vessel 11, wherein the H₂SO₄ solution B, which has lower density than HI solution A, is disposed above HI solution B. In the space above the H₂SO₄ solution B in the reaction vessel 11, gas C produced in the reaction vessel 11, such as oxygen or hydrogen, may exist.

Reaction vessel 11 has a box-shaped (e.g., rectangular) enclosure. In this embodiment, the reaction vessel 11 includes ultrasonic transducer 13 at a bottom 11a of the reaction vessel 11. The reaction vessel 11 shown in FIG. 7 includes three ultrasonic transducers 13 at the outside surface of the bottom 11a. The ultrasonic transducer 13 may be in the bottom 11a of the reaction vessel 11. The ultrasonic transducer 13 includes an ultrasonic probe 16 and an ultrasonic transmitter/receiver (not shown) coupled with the ultrasonic probe 16. The ultrasonic probe 16 is able to transmit or receive ultrasonic waves of a predetermined frequency coupled with the ultrasonic transmitter/receiver.

Reaction vessel 11 further includes an ultrasonic transducer 25 at the side wall 11b, and ultrasonic transducers 26 provided at the opposite side wall 11c which faces the side wall 11b where the ultrasonic transducer 25 is provided. The ultrasonic transducer 25 includes ultrasonic transmission probe 27 coupled with a ultrasonic transducer (not shown), while the ultrasonic transducer 26, which is provided at the opposite side wall 11c against the side wall 11b having the ultrasonic transducer 25, includes an ultrasonic receiving probe 28 coupled with an ultrasonic receiver (not shown). The ultrasonic transmission probe 27 and the ultrasonic receiving probe 28 are provided such that they tilt upwardly against the side wall 11b or 11c. The ultrasonic transmission probe 27 is provided at an upper side of the side wall 11b, where the H₂SO₄ solution B should exist in the reaction vessel. The ultrasonic transducer 28 includes a plurality of ultrasonic receiving probes 28, for example five ultrasonic receiving probes 28 as shown in FIG. 7, aligned in the vertical direction. The ultrasonic transmission probe 27 and ultrasonic receiving probes 28 have directivity.

When the ultrasonic transducer 13 or 25 generates an electric pulse to the ultrasonic probe 16 or 27, ultrasonic waves, which have for example a frequency of 5 MHz, are transmitted from the ultrasonic probe 16 or 27 inside the reaction vessel 11.

The ultrasonic waves transmitted inside the reaction vessel 11 reflect at a liquid-liquid boundary surface Fa, and of a gas-liquid boundary surface Fb due to the difference of the density at these boundaries. These reflected ultrasonic waves are referred to as reflected echoes.

The ultrasonic probe 16 and the ultrasonic receiving probe 28 detect the reflected echoes. The reflected echoes are received and converted to an echo electric signal by the ultrasonic transmitter/receiver coupled with the ultrasonic probe 16 or the ultrasonic receiver coupled with the ultrasonic receiving probe 28. The echo electric signal is sent to a data processing unit (not shown). The data processing unit processes the echo electric signal and calculates positions (height) of the liquid-liquid boundary surface Fa and the gas-liquid boundary surface Fb in the reaction vessel 11 without contact. Results of the calculation are preferably outputted on a display unit (not shown).

The ultrasonic transducer 13, which is provided at the bottom 11a of the reaction vessel, is used to detect the liquid-liquid boundary surface Fa in the reaction vessel 11. FIG. 7 shows a configuration that has three ultrasonic transducers 13 to detect the liquid-liquid boundary surface Fa. The ultrasonic transducers 25, 26, which is provided at the side wall 11b, 11c, are used to detect the gas-liquid boundary surface Fb.

An ultrasonic pulse of the ultrasonic waves transmitted from the ultrasonic probe 16, by the operation of the ultrasonic transducer 13, penetrates through the bottom 11a of the reaction vessel 11 and goes upwardly in the HI solution A in the reaction vessel 11.

The ultrasonic pulse transmitted in the reaction vessel 11 which reaches at the liquid-liquid boundary surface Fa is reflected downwardly as reflected echoes due to the difference of the acoustic impedance between HI solution A and H₂SO₄ solution B, which is resulted from the difference of densities of those solutions. The reflected echoes then come back to the ultrasonic probe 16 through the bottom 11a. The position (height) of the liquid-liquid boundary surface Fa can be calculated based upon time difference between the transmission of the ultrasonic pulse and the receive of the reflected echoes at the ultrasonic probe 16. Compensation of the sound velocity can be accomplished by such a way shown in the first embodiment.

Some part of the ultrasonic pulse transmitted in the reaction vessel 11 penetrates through the liquid-liquid boundary surface Fa, and further goes upwardly in the H₂SO₄ solution B. This ultrasonic pulse is also reflected downwardly as the reflected echoes at the gas-liquid boundary surface Fb and comes back to the ultrasonic probe 16. Therefore, as shown in the first embodiment, the position (height) of the gas-liquid boundary surface Fb may be calculated based upon the time difference between the transmission of the ultrasonic pulse and the reception of the reflected echoes from the gas-liquid boundary surface Fb.

However, multiple reflection which occurs at the liquid-liquid boundary surface Fa may overlap on the reflected echoes from the gas-liquid boundary surface Fb in some situations. In such a situation, it is difficult to detect the reflected echoes from the gas-liquid boundary surface Fb with the ultrasonic probe 16.

The second embodiment shown in FIG. 7 utilizes the ultrasonic transducer 25 and 26 to detect the position (height) of the gas-liquid boundary surface Fb instead of the ultrasonic transducer 13 provided at the bottom 11a.

An ultrasonic pulse of the ultrasonic waves transmitted from the ultrasonic transmission probe 27, by the operation of the ultrasonic transducer 25, penetrates through the side wall 11b of the reaction vessel 11. As mentioned, the ultrasonic transmission probes 27 and 28 have a tilt (e.g., are angled) against the side wall 11b and 11c. Therefore, the ultrasonic pulse is transmitted aslant towards the gas-liquid boundary surface from the ultrasonic transmission probe 27 at an angle ψ against the side wall 11b. The transmitted ultrasonic pulse then reflects at the gas-liquid surface Fb and is received by one of the ultrasonic receiving probes 28. Because an angle of incidence of the ultrasonic pulse received at the ultrasonic receiving probe 28 is also ψ, the position (height) of the ultrasonic receiving probe 28 differs due to the position (height) of the gas-liquid boundary surface Fb. In this embodiment, since a plurality of ultrasonic receiving probes 28 are aligned vertically, the position of the incoming point (height h3) of the reflected echoes, where the reflected echoes reach at the opposite side wall 11c, can be readily detected. The position of the incoming point (height h3) may be determined precisely by a distribution of intensity of reflected echoes detected at the ultrasonic receiving probes 28. Data of detected position of the incoming point is sent to a data processing unit (not shown but see FIG. 2).

When the height from the height h2 of the ultrasonic transmission probe 27 to the detected position h3 of the incoming point of the reflected echoes is dh2, the height d2 of the gas-liquid boundary surface Fb is determined by a formula (9), using the height of the ultrasonic transmission probe 27 as h2, the angle of the transmitted ultrasonic pulse from the ultrasonic transmission probe as A, and the width of the reaction vessel 11, which is a horizontal distance between the ultrasonic transmission probe 27 and the ultrasonic receiving probes 28, as L.

$${d}_{2} = {h}_{2} + \frac{L cot ψ + ( {h}_{3} - {h}_{2} )}{2} = {h}_{2} + \frac{L cot ψ + d {h}_{2}}{2} \qquad ( 9 )$$

With the formula (9), the height d2 of the gas-liquid boundary surface can be determined regardless of the difference of the sound velocity in the H₂SO₄ solution B because it uses geometric information, such as h2, h3, L, and predetermined angle ψ of the ultrasonic probes 27, 28.

According to this embodiment, the liquid-liquid boundary surface Fa and the gas-liquid boundary surface Fb may be determined precisely even if there is multiple reflection occurring at the liquid-liquid boundary surface Fa which overlaps on the reflected echoes from the gas-liquid boundary surface Fb.

Further, it should be noted that this principle for the measurement of the position (height) of the gas-liquid boundary surface Fb can be applied to measure the position (height) of the liquid-liquid boundary surface Fa when using another ultrasonic transmission probe provided at the lower side of the side wall 11b, where the HI solution A should exist in the reaction vessel 11. In such a case, it is not necessary to use the ultrasonic probe 16 provided at the bottom 11a and the means for compensation of the sound speed to detect the position of the liquid-liquid boundary surface Fa. However it may be utilized for further credibility of the measured position of the boundary surfaces Fa and Fb.

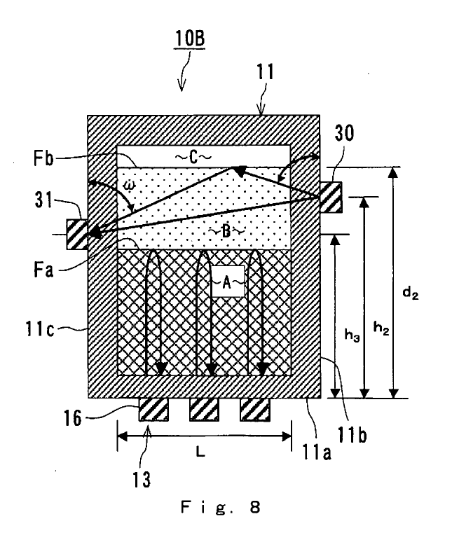

FIG. 8 is a schematic sectional view of a modification of the second embodiment shown in FIG. 7. In FIG. 8, the same numeric symbols are used for the same elements as shown in FIG. 7. Accordingly, detailed descriptions may be omitted for those elements.

The ultrasonic transmission probe 27 and the ultrasonic receiving probe 28 have directivity, and the ultrasonic pulse is transmitted aslant to the gas-liquid boundary surface Fb in the second embodiment shown in FIG. 7. In this modification, the reaction vessel 11 of a hydrogen production apparatus 10B includes an ultrasonic transmission probe 30 provided at the sidewall 11b and an ultrasonic receiving probe 31 provided at the opposite side wall 11c, instead of the ultrasonic transmission probe 27 and ultrasonic receiving probes 28 shown in FIG. 7. The ultrasonic transmission probe 30 and the ultrasonic receiving probe 31 have no directivity. Therefore, the ultrasonic pulse is transmitted from the ultrasonic transmission probe within wide angles. The ultrasonic receiving probe 31 is provided at the upper side of the opposite side wall 11c, where the H₂SO₄ solution B should exist in the reaction vessel 11. It is not necessary to place the ultrasonic receiving probe 31 at the same height as the ultrasonic transmission probe 30.

A part of the ultrasonic pulse transmitted from the ultrasonic transmission probe 30 reaches directly to the ultrasonic receiving probe 31 in the shortest distance. Other part of the ultrasonic pulse reflects at the gas-liquid boundary surface Fb and the reflected echoes reach to the ultrasonic receiving probe 31. An incidence angle ψ of the reflected echoes can be determined by a propagation distance 1 of the reflected echoes from the ultrasonic transmission probe 30 to the ultrasonic receiving probe 31. The incidence angle ω is obtained by using the propagation distance 1 and width L of the reaction vessel 11 as formula (10)

$$sin ω = \frac{L}{l} \qquad ( 10 )$$

The propagation distance 1 can be calculated based upon the time difference between the transmission of the ultrasonic pulse and receive of the reflected echo. When calculating the propagation distance, it is necessary to determine the velocity of sound inside the H₂SO₄ solution B. However, it can be obtained by the time taken to receive the ultrasonic pulse that reaches directly from the ultrasonic transmission probe 30 because a distance between the ultrasonic transmission probe 30 and the ultrasonic receiving prove 31 is readily obtained by geometric position of those probes 30 and 31. Thus, the speed of sound in the H₂SO₄ solution B is compensated and the incidence angle ω can be obtained precisely.

When the incidence angle ω is obtained, the position (height) d2 of the gas-liquid boundary surface Fb is calculated, by using h2 as the height of the ultrasonic transmission probe 30, h3 as the height of the ultrasonic receiving probe 31, as formula (11), which is substantially the same as the formula (9).

$${d}_{2} = {h}_{2} + \frac{L cot ω + ( {h}_{3} - {h}_{2} )}{2} = {h}_{2} + \frac{l cos ω + ( {h}_{3} - {h}_{2} )}{2} \qquad ( 11 )$$

According to this modification, the liquid-liquid boundary surface Fa and the gas-liquid boundary surface Fb may be determined precisely even if there is multiple reflection occurring at the liquid-liquid boundary surface Fa which overlaps on the reflected echoes from the gas-liquid boundary surface Fb, same as the embodiment shown in FIG. 8.

Further, it should be noted that this principle for the measurement of the position (height) of the gas-liquid boundary surface Fb can be applied to measure the position (height) of the liquid-liquid boundary surface Fa when using another ultrasonic transmission probe provided at the lower side of the side wall 11b, where the HI solution A should exist in the reaction vessel 11. In such a case, it is not necessary to use the ultrasonic probe 16 provided at the bottom 11a and the means for compensation of the sound velocity to detect the position of the liquid-liquid boundary surface Fa. However, it may be utilized for further credibility of the measured position of the boundary surfaces Fa and Fb.

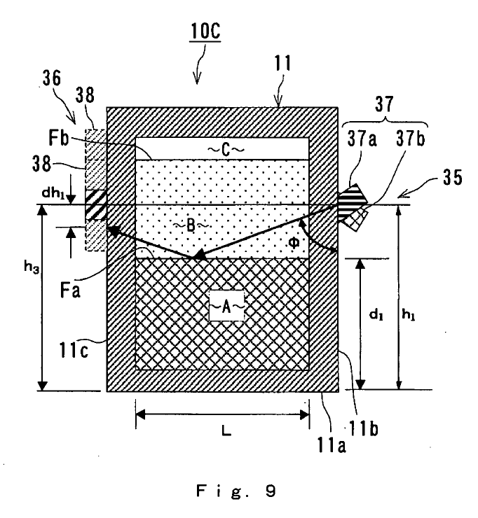

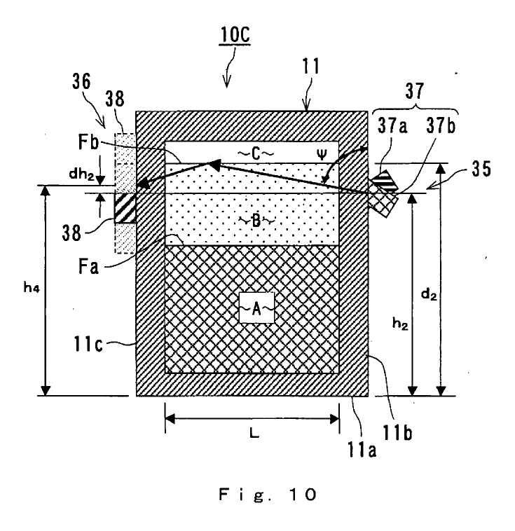

FIGS. 9 and 10 are schematic sectional views of another modification of the second embodiment shown in FIG. 7. In FIGS. 9 and 10, the same numeric symbols are used for the same elements as shown in FIG. 7. Accordingly, detailed descriptions has been omitted for those elements.

In this modification, no ultrasonic transducer is provided at the bottom 11a of the reaction vessel 11. The reaction vessel 11 of a hydrogen production apparatus 10C comprises an ultrasonic transducer 35 provided at the side wall 11b and an ultrasonic transducer 36 provided at the opposite side wall 11c.

The ultrasonic transducer 35 includes an ultrasonic transmission probe unit 37. The ultrasonic transmission probe unit 37 is provided at an upper side of the side wall 11b, where the H₂SO₄ solution B should exist in the reaction vessel. The ultrasonic transmission probe unit 37 comprises a downwardly tilted ultrasonic probe 37a and an upwardly tilted ultrasonic probe 37b. The ultrasonic transducer 36 includes a plurality of ultrasonic receiving probes 38 vertically aligned to each other. The ultrasonic pulse from the downwardly tilted ultrasonic probe 37a is transmitted aslant toward the liquid-liquid boundary surface Fa at an angle Φ, which is a tilted angle of the downwardly tilted ultrasonic probe 37a, against the side wall 11b. The transmitted ultrasonic pulse reflects at the liquid-liquid surface Fa as reflected echoes, and the reflected echoes reach at one of the ultrasonic receiving probes 38 at an incidence angle Φ. The position (height) of an incoming point of the reflected echoes, where the reflected echoes reach at the ultrasonic receiving probes 38, differs when the position (height) of the liquid-liquid boundary surface changes. Therefore, the position (height) d1 of the liquid-liquid boundary surface Fa can be calculated according to the position (height) h3 of the incoming point of the reflected echoes, where the reflected echoes reach at the ultrasonic receiving probes 38. The position (height) h3 of the incoming point of the reflected echoes may be obtained by intensity distribution of the reflected echoes detected by the ultrasonic receiving probes 38. When the vertical distance from the position (height) h1 of the downwardly tilted ultrasonic probe 37a to the position (height) h3 of the incoming point is defined as dh1, which is h3-h1, the height d1 of the liquid-liquid boundary surface Fa is calculated by a formula (12), using the width L of the reaction vessel 11.

$${d}_{1} = {h}_{1} - \frac{L cot ϕ + ( {h}_{3} - {h}_{1} )}{2} = {h}_{1} - \frac{L cot ϕ + d {h}_{1}}{2} \qquad ( 12 )$$

The gas-liquid boundary surface Fb can be calculated in the same manner by utilizing the upwardly tilted ultrasonic probe 37b as shown in FIG. 10. When defining a incidence angle of the transmission of the ultrasonic pulse against the side wall 11b as Ψ, the position (height) d2 of the gas-liquid boundary surface Fb can be obtained as formula (13) by using the height dh2 from the height h2 of the upwardly tilted ultrasonic probe 37b to the height h4 of the incoming point of the reflected echoes, where the reflected echoes reach at the ultrasonic receiving probe 37b, and width L of the reaction vessel 11.

$${d}_{2} = {h}_{2} + \frac{L cot ψ + ( {h}_{4} - {h}_{2} )}{2} = {h}_{2} + \frac{L cot ψ + {dh}_{2}}{2} \qquad ( 13 )$$

In this modification, the ultrasonic transducer 36 may include an ultrasonic receiving probe, which is movable in the vertical direction, instead of a plurality of ultrasonic receiving transducers 38 aligned vertically. In this modification, it is important to measure the position (height) of the incoming point of the reflected echoes.

According to this modification, the liquid-liquid boundary surface Fa and the gas-liquid boundary surface Fb may be determined precisely regardless of the changing of the speed of sound (sound velocity) in the reacting liquids.

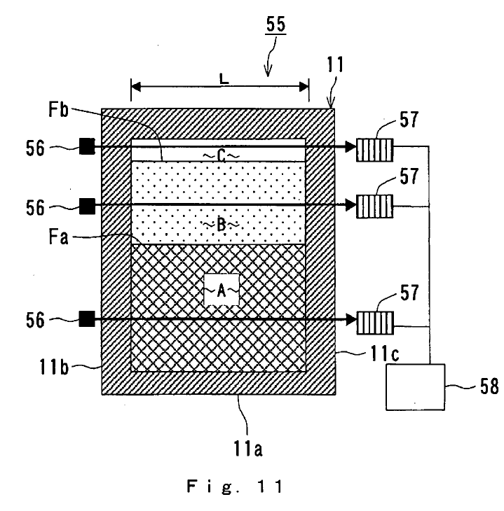

FIG. 11 is a schematic sectional view of an apparatus for producing hydrogen by IS process in accordance with the third embodiment.

A hydrogen production apparatus 55, which produces hydrogen continuously by IS process, can detect constituent (component) and concentration (density) of the reacting liquid inside the apparatus.

A reaction vessel 11 of the hydrogen producing apparatus 55 encloses hydriodic acid (HI) solution A and sulfuric acid (H₂SO₄) solution B resulted from the Bunsen reaction. Hydriodic acid (HI) solution A and sulfuric acid (H₂SO₄) solution B are both in a liquid state, as reacting liquids.

Since HI solution A and H₂SO₄ solution B (also referred to as reacting liquids) are non-mixing liquid with respect to each other, they are separately held in the reaction vessel 11, wherein the H₂SO₄ solution B, which has lower density than HI solution A, is disposed above HI solution B. In the space above the H₂SO₄ solution B in the reaction vessel 11, gas C produced in the reaction vessel 11, such as oxygen or hydrogen may exist.

Reaction vessel 11 has a box-shaped (e.g., rectangular) enclosure. The reaction vessel 11 of the hydrogen production apparatus 55 comprises a plurality of gamma-ray sources 56 provided at the side wall 11b as radiation source, and radiation detectors 57 provided at the opposite side wall 11c, which faces toward the side wall 11b with the gamma-ray sources 56. The radiation detectors 57 are connected to a data processing unit 58. Thus the data detected at the radiation detectors 57 are sent to the data processing unit 58.

Each of the gamma-ray sources 56 is provided separately in the vertical direction, and the each of the radiation detector 57 is provided at the opposite side wall 11c on the height corresponding to the gamma-ray source 56 at the side wall 11b. The gamma-ray source 56 and the corresponding radiation detector 57 are provided such that the gamma ray emitted from the gamma-ray source 56 to the corresponding radiation detector 57 transmits horizontally through the reaction vessel 11. FIG. 11 shows an example which includes three gamma-ray sources 56 and three radiation detectors 57. In this embodiment, one set of the gamma-ray source 56 and the radiation detector 57 is provided at the position where the HI solution A should exist in the reaction vessel 11, another set is provided at the position where the H₂SO₄ solution B should exist in the reaction vessel 11, and the last set is provided at the position where the gas C should exist in the reaction vessel 11.

The gamma-ray source 56 emits gamma ray toward the corresponding radiation detector 57. The gamma ray emitted from the gamma-ray source 56 transmits through HI solution A, the H₂SO₄ solution B or gas C, respectively, and reaches to the radiation detector 57. A correlation between the count and intensity of gamma ray detected at the radiation counter 57 is given by the formula (14).

$$\frac{{A}_{i}}{4 π {L}^{2}} = exp \{ - ( {σ}_{1 i} {ρ}_{1} + {σ}_{2 i} {ρ}_{2} + {σ}_{3 i} {ρ}_{3} + {σ}_{4 i} {ρ}_{4} + {σ}_{5 i} {ρ}_{5} ) \cdot L \} \cdot \frac{1}{{f}_{i}} {N}_{i} , \qquad ( 14 )$$

where the numeric symbols used in the formula are as below;

σ: cross section of absorption of the gamma ray with energy i emitted from the gamma ray source 56 (characteristic value by the energy of the gamma-ray and the substance)

ρ: density

L: width of the reaction vessel 11

fᵢ: sensitivity of the radiation detector 57 for the gamma ray with energy i emitted from the gamma ray source 56 (including the effect of attenuation of the radiation by the reaction vessel)

Aᵢ: number of the gamma ray with energy i emitted from the gamma ray source 56 per unit time

Nᵢ: count of the radiation detector 57 against the gamma ray with energy i emitted from the gamma ray source 56

ρ₁: density of gas

ρ₂: density of fluid

ρ₃: density of hydriodic acid

ρ₄: density of water

ρ₅: density of iodine

In the formula (14), the number A of the emitted radiation, the width L of the reaction vessel 11, and the sensitivity f of the radiation detector 57, are known information. Further, the count N of the radiation detector 57 can be obtained as a measured value. Therefore, substituting those values in the formula (14), the product σ*ρ of the gamma-ray absorption cross section σ and the density ρ can be obtained.

The product σ*ρ of the gamma-ray absorption cross section σ and the density ρ can be expressed as;
σ*ρ=σ₁ᵢ*ρ₁+σ₂ᵢ*ρ₂+σ₃ᵢ*ρ₃+σ₄ᵢ*ρ₄+σ₅ᵢ*ρ₅ (15)

σ₁ᵢ*ρ₁, which is regarding the gas in the right-hand side of the formula (15), is relatively smaller than the value regarding the liquids. Thus, the approximations (16) described below can be satisfied.
σ₁ᵢ*ρ₁<<σ₂ᵢ*ρ₂
σ₁ᵢ*ρᵢ<<σ₃ᵢ*ρ₃
σ₁ᵢ*ρ₁<<σ₄ᵢ*ρ₄
σ₁ᵢ*ρ₁<<σ₅ᵢ*ρ₅ (16)

When the substance, which the radiation transmits through, is gas (which means ρ₂=ρ₃=ρ₄=ρ₅=0), the product σ*ρ satisfies the formula σ*ρ=σ₁ᵢ*ρ₁. In such a situation, the product σ*ρ is much smaller than the situation when the radiation transmits through liquid. Therefore, one can determine the substance, which the radiation transmits through, is gas. Furthermore, the gamma-ray absorption cross section σ₁ᵢ is a known value. Thus the density of the gas ρᵢ can be obtained by dividing the product σ*ρ by σ₁ᵢ.

On the other hand, when the substance, which the radiation transmits through, is liquid, the product σ*ρ of the gamma-ray absorption cross section σ and the density ρ is much larger than the situation when the radiation transmits through gas. Therefore one can determine the substance, which the radiation transmits through, is liquid. Discrimination of the constituent and calculation of the density can be accomplished as described below. When emitting four energies (i=1 to 4), the formula (14) are as follow.

$$\frac{{A}_{1}}{4 π {L}^{2}} = exp \{ - ( {σ}_{21} {ρ}_{2} + {σ}_{31} {ρ}_{3} + {σ}_{41} {ρ}_{4} + {σ}_{51} {ρ}_{5} ) \cdot L \} \cdot \frac{1}{{f}_{1}} {N}_{1} \\ \frac{{A}_{2}}{4 π {L}^{2}} = exp \{ - ( {σ}_{22} {ρ}_{2} + {σ}_{32} {ρ}_{3} + {σ}_{42} {ρ}_{4} + {σ}_{52} {ρ}_{5} ) \cdot L \} \cdot \frac{1}{{f}_{2}} {N}_{2} \\ \frac{{A}_{3}}{4 π {L}^{2}} = exp \{ - ( {σ}_{23} {ρ}_{2} + {σ}_{33} {ρ}_{3} + {σ}_{43} {ρ}_{4} + {σ}_{53} {ρ}_{5} ) \cdot L \} \cdot \frac{1}{{f}_{3}} {N}_{3} \\ \frac{{A}_{4}}{4 π {L}^{2}} = exp \{ - ( {σ}_{24} {ρ}_{2} + {σ}_{34} {ρ}_{3} + {σ}_{44} {ρ}_{4} + {σ}_{54} {ρ}_{5} ) \cdot L \} \cdot \frac{1}{{f}_{4}} {N}_{4} \qquad ( 17 )$$

In the formula (17), the numbers A₁ to A₄ of the emitted radiation, the width L of the reaction vessel 11, the sensitivities f₁ to f₄ of the radiation detector 57, and the gamma-ray absorption cross section σⱼᵢ (i=1 to 4, j=1 to 4) are known information. Further, the count N of the radiation detector 57 can be obtained by measurements.

Therefore, the solution for the equations (17) can be solved. Thus, the densities ρ₂, ρ₃, ρ₄, and ρ₅ can be obtained, and the constituents and density of the substance in the reaction vessel 11 are identified. The data processing unit 58 may store data regarding constituents in each layer in the reaction vessel 11 and cross sections of absorption of each gamma ray emitted from the gamma ray sources for the constituents for the calculation described above.

The embodiment described above is to identify the constituents and densities for four constituent liquids; however, the gamma-ray sources emitting N species of gamma-ray having different energies can be applied to identify the constituents and densities for N of constituent liquids.

The embodiment shown in FIG. 11 utilizes gamma-ray source 56 as radioactive sources, however neutron sources can be applied to identify the constituents and density (concentration) of the liquid in the same manner described above.

According to the embodiment, the constituent and concentration (density) of the liquid enclosed in the reaction vessel 11 can be identified from the outside of the reaction vessel without contacting any of the liquids.

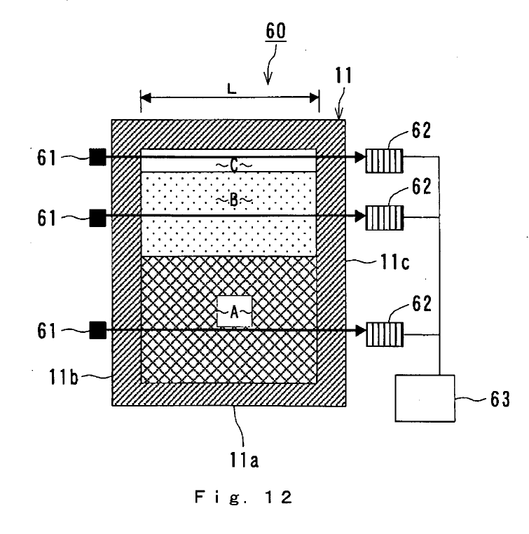

FIG. 12 is a schematic sectional view of an apparatus for producing hydrogen by IS process in accordance with the fourth embodiment.

A hydrogen production apparatus 60, which produces hydrogen continuously by IS process, can detect constituent (component) and concentration (density) of the reacting liquid inside the apparatus.

A reaction vessel 11 of the hydrogen producing apparatus 60 encloses hydriodic acid (HI) solution A and sulfuric acid (H₂SO₄) solution B resulted from the Bunsen reaction. Hydriodic acid (HI) solution A and sulfuric acid (H₂SO₄) solution B are both in a liquid state, as reacting liquids.

Since HI solution A and H₂SO₄ solution B (also referred to as reacting liquids) are non-mixing liquid with each other, they are separately held in the reaction vessel 11, wherein the H₂SO₄ solution B, which has lower density than HI solution A, is provided above HI solution B. In the space above the H₂SO₄ solution B in the reaction vessel 11, gas C produced in the reaction vessel 11, such as oxygen or hydrogen may exist.

Reaction vessel 11 has a box-shaped (e.g., rectangular) enclosure. The reaction vessel 11 of the hydrogen production apparatus 60 comprises a plurality of neutron sources 61 provided at the side wall 11b as radiation sources, and gamma-ray detectors 62 provided at the opposite side wall 11c as radiation detectors, which faces toward the side wall 11b with the neutron sources 61. The gamma-ray detectors 62 are connected to the data processing unit 58. Thus, the data detected at the radiation detectors 57 are sent to the data processing unit 58.

Each of the neutron sources 56 is provided separately in the vertical direction, and the each of the gamma-ray detector 62 is provided at the opposite side wall 11c on the height corresponding to the neutron source 61 at the side wall 11b. The neutron source 61 and the gamma-ray detector 62 are provided such that the neutron from the neutron source 61 penetrates (transmits) horizontally through the reaction vessel 11 to the corresponding gamma-ray detector 62. FIG. 12 shows an example which includes three neutron sources 61 and three gamma-ray detectors 62. In this embodiment, one set of the neutron source 61 and the radiation detector 62 is provided at the position where the HI solution A should exist in the reaction vessel 11, another set is provided at the position where the H₂SO₄ solution B should exist in the reaction vessel 11, and the last set is provided at the position where the gas C should exist in the reaction vessel 11.

The gamma-ray detectors 62 detect neutron capture gamma-ray, whose intrinsic energy differs by the substance which the neutron penetrates (transmits) through. In this embodiment, utilizing this difference identifies constituents and densities of the substance in the reaction vessel 11.

The neutron source 61 emits neutron toward the corresponding gamma-ray detector 62. The neutron emitted from the neutron source 61 penetrates (transmits) through HI solution A, the H₂SO₄ solution B or gas C, respectively, and are captured by constituents in the substance A, B or C in a probability characteristic to those constituents. A molecule of the constituent of the substance A, B or C that captures the neutron radiates gamma-ray, which has an energy characteristic corresponding to the constituent of the substance.

For example, this energy of gamma-ray (also referred to as “characteristic gamma-ray energy”), which is a characteristic of the constituent of the substance, is 2.22 MeV for hydrogen, 4.14 MeV for oxygen, 8.64 MeV for sulfur, 6.83 MeV for iodine, and 7.65 MeV for iron, which is the main component of reaction vessel 11, when the thermal neutron is captured. A count of gamma rays having any particular energy (which means any particular element regarding to the particular energy) can be obtained by, for example, pulse height discrimination based upon the difference of the characteristic gamma-ray energy regarding the constituent of the substances by any neutron energy.

The count Nj at the gamma-ray detector 62 of the gamma ray, which has the characteristic gamma-ray energy due to the capture of the neutron in the constituents of the substances (elements), is expressed by the formula (18) by assuming the number of the constituents of the substance is j, wherein j=1 to n.

$$\frac{1}{{f}_{j}} {N}_{j} = \frac{{B}_{j} {σ}_{j} {ρ}_{j}}{{\sum }_{i = 1}^{n} {σ}_{i} {ρ}_{i}} ( 1 - exp \{ - {\sum }_{i = 1}^{n} {σ}_{i} {ρ}_{i} \cdot L \} ) \cdot ϕ \qquad ( 18 )$$

where the numeric symbols used in the formula are as below;

σᵢ: (n,gamma) corss section for the element i (characteristic value depends on the energy of emitted neutron and the constituent of the substance (element))

Bⱼ: gamma-ray branching ratio (ratio of the gamma ray having characteristic energy in all of the neutron capture gamma-ray for the element j)

ρᵢ: density of the element i (i=1 to n)

L: width of the reaction vessel 11

fᵢ: sensitivity of the radiation detector for the characteristic gamma-ray energy of species j (including such as a compensation of solid angle due to the distance between the position of the neutron reaction and the radiation detector)

Φ: neutron flux (1/cm²/s)

Since formula (18) is satisfied for each of characteristic energies for n species of the constituents of the substance (element). Therefore, the formula (18) constitutes simultaneous equations, expressly,

$$\frac{1}{{f}_{1}} {N}_{1} = \frac{{B}_{1} {σ}_{1} {ρ}_{1}}{{\sum }_{i = 1}^{n} {σ}_{i} {ρ}_{i}} ( 1 - exp \{ - {\sum }_{i = 1}^{n} {σ}_{i} {ρ}_{i} \cdot L \} ) \cdot ϕ \\ \frac{1}{{f}_{2}} {N}_{2} = \frac{{B}_{2} {σ}_{2} {ρ}_{2}}{{\sum }_{i = 1}^{n} {σ}_{i} {ρ}_{i}} ( 1 - exp \{ - {\sum }_{i = 1}^{n} {σ}_{i} {ρ}_{i} \cdot L \} ) \cdot ϕ \\ … \\ \frac{1}{{f}_{n}} {N}_{n} = \frac{{B}_{n} {σ}_{n} {ρ}_{n}}{{\sum }_{i = 1}^{n} {σ}_{i} {ρ}_{i}} ( 1 - exp \{ - {\sum }_{i = 1}^{n} {σ}_{i} {ρ}_{i} \cdot L \} ) \cdot ϕ \qquad ( 19 )$$

In equations (19), reaction cross section σᵢ, gamma-ray branching ratio Bⱼ, width L of the reaction vessel 11, sensitivity fᵢ of the radiation detector 62, and neutron flux Φ are known information. Further, the count Ni can be measured at the radiation detector 62. Thus, the densities ρᵢ (i=1 to n) of the constituents of the substance (element) are the only unknown quantities in equation (19). Since the number of the equations (19) and unknown quantities are both n, one set of solution for the unknown quantities can be obtained by solving the simultaneous equations (19). Therefore, the densities ρᵢ (i=1 to n) of the constituents of the substance (element) are obtained.

The densities ρᵢ of the constituents of the substance (element) and the densities of the components of the solution A and B, which are sulfuric acid molecule (H₂SO₄), water molecule (H₂O), iodine molecule (I₂), and hyriodic acid (HI), satisfy simultaneous equations (20) as below.

$$ρ ( S ) = \frac{A ( S )}{A ( {H}_{2} {SO}_{4} )} ρ ( {H}_{s} {SO}_{4} ) \\ ρ ( I ) = \frac{A ( I )}{A ( HI )} ρ ( HI ) + ρ ( {I}_{2} ) \\ \begin{matrix}ρ ( H ) = \frac{A ( {H}_{2} )}{A ( {H}_{2} {SO}_{4} )} ρ ( {H}_{s} {SO}_{4} ) + \\ \frac{A ( {H}_{2} )}{A ( {H}_{2} O )} ρ ( {H}_{s} O ) + \frac{A ( I )}{A ( HI )} ρ ( HI )\end{matrix} \\ ρ ( O ) = \frac{A ( {O}_{4} )}{A ( {H}_{2} {SO}_{4} )} ρ ( {H}_{s} {SO}_{4} ) + \frac{A ( O )}{A ( {H}_{2} O )} ρ ( {H}_{s} O ) \qquad ( 20 )$$

Where;

ρ(x) means the density of the constituent of the substance x, and

A(x) means the molecular weight of the element x

In the simultaneous equations (20), which comprises four equations, there are four unknown quantities, ρ(H₂SO₄), ρ(HI), ρ(I₂), and ρ(H₂O). Therefore, the simultaneous equations (20) can be solved and the densities (concentrations) of the solution A, B and gas C in the reaction vessel 11 can be identified.

The data processing unit 63 may store data regarding the constituents of the substances in the reaction vessel 11, and reaction cross section for the constituents of the substances (elements) for the calculation described above in the data processing unit 63.

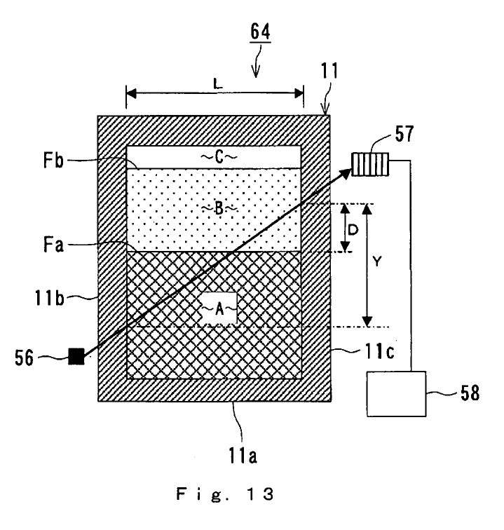

FIG. 13 is a schematic sectional view of an apparatus for producing hydrogen by IS process in accordance with the fifth embodiment.

A hydrogen production apparatus 64, which produces hydrogen continuously by the IS process, can detect positions of boundary surfaces inside the apparatus.

A reaction vessel 11 of the hydrogen producing apparatus 64 encloses hydriodic acid (HI) solution A and sulfuric acid (H₂SO₄) solution B resulted from the Bunsen reaction. Hydriodic acid (HI) solution A and sulfuric acid (H₂SO₄) solution B are both in a liquid state, as reacting liquids.

Since HI solution A and H₂SO₄ solution B (also referred to as reacting liquids) are non-mixing liquids that do not mix with each other, they are separately held in the reaction vessel 11, wherein the H₂SO₄ solution B, which has lower density than HI solution A, is laid above HI solution B. In the space above the H₂SO₄ solution B in the reaction vessel 11, gas C produced in the reaction vessel 11, such as oxygen or hydrogen may exist.

Reaction vessel 11 has a box-shaped (e.g., rectangular) enclosure. The reaction vessel 11 of the hydrogen production apparatus 64 comprises a gamma-ray source 56 provided at a lower side of the side wall 11b as a radiation source, and a radiation detector 57 provided at an upper side of the opposite side wall 11c, which faces toward the side wall 11b with the gamma-ray sources 56. The radiation detectors 57 are connected to a data processing unit 58. Thus, the data detected at the radiation detectors 57 are sent to the data processing unit 58. The data processing unit 58 calculates the position of the boundary surfaces inside the reaction vessel 11. The calculated result from the data processing unit 58 may be displayed on a display (not shown).

The gamma-ray source 56 emits gamma ray toward the radiation detector 57. The gamma ray emitted from the gamma-ray source 56 transmits the reaction vessel 11 through the radiation detector 57 goes horizontally through the reaction vessel 11. As shown in FIG. 13, the gamma ray passes aslant through two reacting liquids, which are the solution A and B, in the reaction vessel 11 from the lower side to the upper side. The gamma ray which transmits through the reaction vessel 11 is detected at the radiation detector 57, which is provided at the upper side of the opposite side wall 11c.

A relation between the intensity of the gamma ray emitted from the gamma-ray source 56 and a count of the gamma ray detected at the radiation detector 57 is expressed in the formula (21) shown below.

$$\frac{A}{4 {π ( {l}_{1} + {l}_{2} )}^{2}} = exp \{ - ( σρ {l}_{1} + {σ}^{′} {ρ}^{′} {l}_{2} ) \} \cdot \frac{1}{f} N \qquad ( 21 )$$

where the numeric symbols used in the formula are as below;

l₁: distance that the gamma ray passes through in the solution A,

l₂: distance that the gamma ray passes through in the solution B.

σ: gamma-ray absorption cross section of the solution A

σ′: gamma-ray absorption cross section of the solution B

ρ: density of the solution A,

ρ′: density of the solution B.

f: sensitivity of the radiation detector 57 for the gamma-ray source 56

A: number of the radiation emitted to the direction 4π by the gamma-ray source 56 per unit time

N: count of the radiation detector 57 against the gamma-ray source 56

When defining the height that the gamma ray passes through inside the reaction vessel as Y and the height that the gamma ray passes through in the H₂SO₄ solution B as D, the formula (22) is satisfied.

$$\frac{{l}_{1}}{D} = \frac{{l}_{2}}{Y - D} \qquad ( 22 )$$

Further, there is a relationship between the l₁, l₂, Y and the width L of the reaction vessel 11 as:
(l₁+l₂)²=Y²+L² (23)

Therefore, formula (21) can be rewritten as:

$$\frac{A}{4 π ( {Y}^{2} + {L}^{2} )} = exp \{ - ( σρ \frac{Y - D}{Y} \sqrt{{Y}^{2} + {L}^{2}} + {σ}^{′} {ρ}^{′} \frac{D}{Y} \sqrt{{Y}^{2} + {L}^{2}} ) \} \cdot \frac{1}{f} N \qquad ( 24 )$$

In the formula (24), height Y that the gamma ray passes through in the solutions, width L of the reaction vessel 11, number A of the radiation, and sensitivity f of the radiation detector 57 are known information. Therefore, the radiation detector 57 can measure count N.

Further, the product of the gamma-ray absorption and the density, such as σ*ρ and σ′*ρ′, can be obtained according to the third embodiment shown in FIG. 11. Therefore, the height D that the gamma ray passes through in the H₂SO₄ solution B can be obtained according to the formula (24). Thus, the height of the liquid-liquid boundary surface Fa is obtained in accordance with this embodiment.

The gamma-ray source 56 might be a neutron source instead of the gamma-ray source 56 shown in FIG. 13. The height of the liquid-liquid boundary surface Fa can be calculated in the same manner as explained above in that situation.

According to this embodiment, the liquid-liquid boundary surface Fa inside the reaction vessel 11 can be obtained from outside of the reaction vessel without physically contacting the reaction vessel. When the principle explained in the third or the forth embodiment is applied to this embodiment, the constituent (component) and the concentration (density) may also be obtained according to this embodiment.

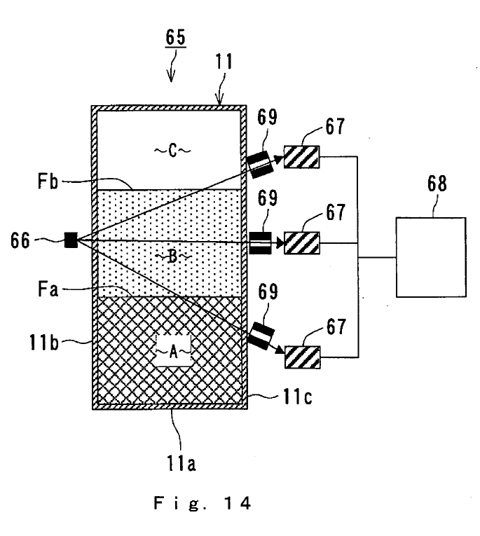

FIG. 14 is a schematic sectional view of an apparatus for producing hydrogen by the IS process in accordance with the sixth embodiment.

A hydrogen production apparatus 65, which produces hydrogen continuously by the IS process, can detect positions of boundary surfaces inside the apparatus. The hydrogen production apparatus 65 can also obtain density (concentration) of a substance of the reacting liquids inside the apparatus. The density is calculated based upon absorption property of sulfur and iodine, which is included in the reacting liquids, against a neutron.

A reaction vessel 11 of the hydrogen producing apparatus 65 encloses hydriodic acid (HI) solution A and sulfuric acid (H₂SO₄) solution B resulted from the Bunsen reaction. Hydriodic acid (HI) solution A and sulfuric acid (H₂SO₄) solution B are both in a liquid state, as reacting liquids.

Since HI solution A and H₂SO₄ solution B (also referred to as reacting liquids) are non-mixing liquids that do not mix with each other, they are separately held in the reaction vessel 11, wherein the H₂SO₄ solution B, which has lower density than HI solution A, is laid above HI solution B. In the space above the H₂SO₄ solution B in the reaction vessel 11, gas C produced in the reaction vessel 11, such as oxygen or hydrogen may exist.

Reaction vessel 11 has a box-shaped (e.g., rectangular) enclosure. The reaction vessel 11 of the hydrogen production apparatus 65 comprises a DT neutron source 66, energy sensitive neutron detectors 67, a data processing unit 68, and neutron collimators 69. The DT neutron source 66 is provided at the side wall 11b as a radiation source. The energy sensitive neutron detectors 67 is provided at the opposite side wall 11c, which faces toward the side wall 11b with the gamma-ray sources 56. The data processing unit 68 processes and analyzes data detected at the neutron detector 67 to calculate the height of a liquid-liquid boundary surfaces Fa and a gas-liquid boundary surface Fb. The neutron collimators 69 detect the effect of scattered radiation of neutron to the neutron detector 67. The energy sensitive neutron detectors 67 are connected to the data processing unit 68. Thus, the data detected at the detectors 68 are sent to the data processing unit 68. The calculated result of the boundary surfaces Fa and Fb from the data processing unit 68 may be displayed on a display (not shown).

Each of the energy sensitive neutron detectors 67 is provided separately in the vertical direction. Each of the neutron collimators 69 is coupled to each of the energy sensitive neutron detector 67 and provided adjacent to the energy sensitive neutron detectors 67 to filter the scattered radiation of a neutron. FIG. 14 shows an example which includes three energy sensitive neutron detectors 67 and three neutron collimators 69.

The DT neutron source 66 emits neutrons. The neutron emitted from the DT neutron source 66 has various energies including scattering component. For example, the neutron emitted from the DT neutron source 66 has a maximum intensity of 14 MeV. The neutron, which has having various energies, is emitted within a certain angle in the reaction vessel 11.

In FIG. 14, the neutron is emitted directly to the reaction vessel 11 from the DT neutron source 66. However, a neutron moderator or an energy discriminator may be provided between the DT neutron source 66 and the reaction vessel 11. The neutron moderator may help flattening energy distribution of the neutron to be emitted in the reaction vessel 11. The energy discriminator may help emitting only neutrons having particular energy to the reaction vessel 11.

A neutron source other than DT neutron source 66 may be used in this embodiment. It is preferable to use a neutron source that radiates neutrons having particular energy corresponding to the neutron resonance of the substance inside the reaction vessel 11.

The neutron emitted from the DT neutron source 66 penetrates (transmits) through the reaction vessel 11 and reaches the energy sensitive neutron detectors 67 via the neutron collimators 69. The densities of the reacting liquids in the reaction vessel 11 can be calculated in the data processing unit 68 in the same manner as explained in the forth embodiment shown in FIG. 12. Also, the heights of the boundary surfaces Fa and Fb can be calculated in the data processing unit 68 in the same manner as explained in the fifth embodiment shown in FIG. 13.

In this embodiment, the neutron collimators 69, provided between the reaction vessel 11 and the energy sensitive neutron detectors 67, reduce the effect of the scattered neutron to the neutron detector 67. The neutron collimators 69 may be provided between the DT neutron source 66 and the reaction vessel 11 to emit neutrons only in particular directions. In such a case, signal-noise ratio of the energy sensitive neutron detectors 67 may be improved.

The accuracy of the calculated density and height of the boundary surfaces Fa, Fb at the data processing unit 68 may be improved in a manner as described below.

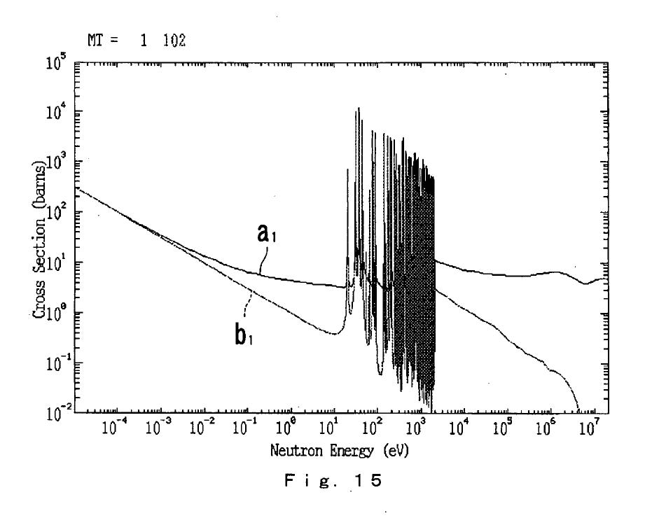

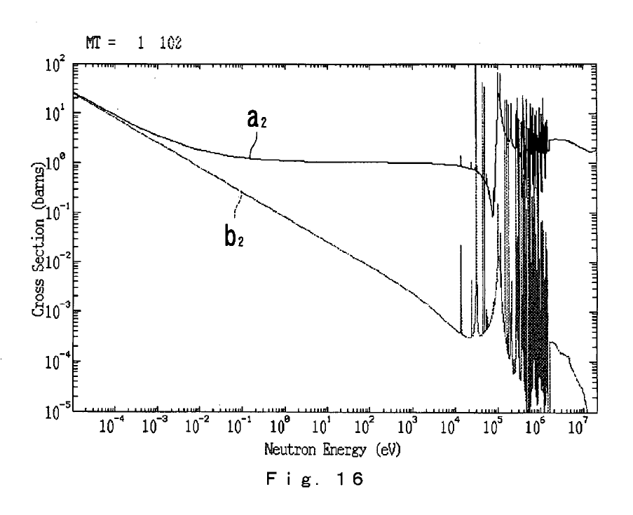

FIGS. 15 and 16 are graph showing the relations between neutron energy and a neutron reaction cross section or a neutron absorption cross section of sulfur and iodine, respectively (Citation from Nuclear Data Center, Japan Atomic Energy Research Institute: “Chart of the Nuclides 2000,” http://wwwndc.tokai.jaeri.go.jp/CN00/index.html (2001.12.16)). In FIGS. 15 and 16, the neutron reaction cross section is shown as solid lines a1 and a2, while the neutron absorption cross section is shown as solid lines b1 and b2.

The neutron reaction cross section is defined as a ratio that a reaction between the substance and the neutron having certain energy occurs. In other words, it is defined as a ratio that the neutron having certain energy is eliminated due to the reaction with the substance. On the other hand, the neutron absorption cross section is defined as a ratio that the neutron having certain energy is absorbed in the substance. The neutron absorption cross section is included in the neutron reaction cross section as one of the reaction. Most of the difference between the neutron reaction cross section and the neutron absorption cross section is due to a reaction that the neutron loses its energy when the neutron and the substance scatter.

In FIGS. 15 and 16, the neutron reaction cross section drastically changes around the energy within the neutron resonance absorption. On the other hand, the neutron absorption cross section drastically increases around the energy within the neutron resonance absorption. According to FIGS. 15 and 16, it can be found that sulfur and iodine have an energy range of the neutron resonance absorption that the neutron absorption cross section drastically swings with particular neutron energy. It is generally known that hydrogen and oxygen do not have neutron resonance absorption below 14 MeV.

In the other words, because iodine has an energy range of the neutron resonance absorption around 1 MeV, the neutron having energy of 1 MeV is greatly absorbed in iodine. The distance that the neutron penetrates (transmits) through the constituent including iodine can be estimated according to attenuation based upon this absorption. Especially, because changes are more drastic for the neutron absorption cross section than for the neutron reaction cross section, it is effective to include neutrons whose energy is reduced due to scattering for count at the energy sensitive neutron detector 67. The distance which a neutron penetrates (transmits) through the liquid containing iodine, such as the HI solution A, may be corrected according to a distribution of a section against energy, such as a ratio of attenuation of a neutron in a range out of the neutron resonance absorption around 1 MeV and attenuation of a neutron in a range of the neutron resonance absorption.

For example, because the neutron reaction cross section gets smaller when the energy is lower than the energy which the neutron resonance absorption will occur, the distance which the neutron penetrates (transmits) through may be corrected according to a characteristic against the energy and a ratio of the neutron.

In the same manner, since sulfur has an energy range of the neutron resonance absorption around 1 keV, attenuation of a neutron having 1 keV is greater in this energy range. Therefore, the distance that the neutron penetrates (transmits) through the liquid containing sulfur may be estimated in the same manner as explained above. The distance that the neutron penetrates (transmits) through may also be corrected according to the ratio of attenuation of the neutron in a range out of the neutron resonance absorption around the range of the neutron resonance absorption and attenuation of the neutron in the range of the neutron resonance absorption.

The distance, which the neutron penetrates (transmits) through substance containing certain constituent, can be calculated according to attenuation of the neutron in three or more energy ranges, which include the energy range of the neutron resonance absorption of sulfur, the energy range of the neutron resonance absorption of iodine, and an energy range, in which neutron resonance absorption of sulfur or iodine does not occur, mainly comprising hydrogen scattering. Densities can be calculated according these values.

According to the embodiment shown in FIG. 14, the densities and the height of boundary surfaces of the reacting liquids can be calculated by measuring attenuation of neutron due to radiation. The accuracy of the calculated densities and height of the boundary surface can be improved by using the neutron of a certain energy range in which neutron resonance absorption occurs.

Other embodiments of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. An apparatus for producing hydrogen by an IS process, comprising:
a reaction vessel, in which reacting liquids are to be introduced;
a first ultrasonic probe, provided at a bottom of the reaction vessel, to detect a position of a boundary surface of the reacting liquids; and
a second ultrasonic probe, provided at a side wall of the reaction vessel, to compensate a sound velocity.

2. The apparatus for producing hydrogen by an IS process according to claim 1, further comprising an ultrasonic transmitter/receiver connected to at least one of the first and the second ultrasonic probes.

3. The apparatus for producing hydrogen by an IS process according to claim 2, further comprising a data processing unit connected to the ultrasonic transmitter/receiver.

4. The apparatus for producing hydrogen by an IS process according to claim 1, further comprising:
a third ultrasonic probe, provided at a side wall facing toward the second ultrasonic probe, to compensate the sound velocity;
an ultrasonic transmitter/receiver connected to the first ultrasonic probe;
an ultrasonic transmitter connected to the second ultrasonic probe; and
an ultrasonic receiver connected to the third ultrasonic probe.

5. The apparatus for producing hydrogen by an IS process according to claim 4, further comprising a data processing unit connected to at least one of the ultrasonic transmitter/receiver, the ultrasonic transmitter, and the ultrasonic receiver.

6. The apparatus for producing hydrogen by an IS process according to claim 4, wherein the second ultrasonic probe is angled with respect to the side wall.

7. An apparatus for producing hydrogen by an IS process, comprising:
a reaction vessel, in which reacting liquids are to be introduced;
a first ultrasonic probe, provided at a bottom of the reaction vessel, to detect a position of a boundary surface between the reacting liquids; and
a means for compensating a sound speed in the reacting liquids in the reaction vessel.

8. The apparatus for producing hydrogen by an IS process according to claim 7, wherein the means for compensating the sound speed is a thermometer provided in the reaction vessel.

9. The apparatus for producing hydrogen by an IS process according to claim 7, wherein the means for compensating the sound velocity is a sampling line connected to the reaction vessel.

10. An apparatus for producing hydrogen by an IS process, comprising:
a reaction vessel, in which reacting liquids are to be introduced;
an ultrasonic transmission probe provided at a first side wall of the reaction vessel;
an ultrasonic receiving probe provided at a second side wall which faces to the first side wall where the first ultrasonic probe is provided;
an ultrasonic transmitter connected to the ultrasonic transmission probe;
an ultrasonic receiver connected to the ultrasonic receiving probe; and
a data processing unit connected to the ultrasonic transmitter and the ultrasonic receiver, which calculates a position of a boundary surface of the reacting liquid inside the reaction vessel.

11. The apparatus for producing hydrogen by an IS process according to claim 10, wherein the ultrasonic transmission probe transmits ultrasonic waves upwardly at an angle.

12. The apparatus for producing hydrogen by an IS process according to claim 10, wherein the ultrasonic receiving probe detects a height of a point where the ultrasonic waves is received.

13. The apparatus for producing hydrogen by an IS process according to claim 12, wherein the ultrasonic transmission probe includes an, upwardly tilted ultrasonic probe and a downwardly tilted ultrasonic probe.

14. The apparatus for producing hydrogen by an IS process according to claim 12, wherein the ultrasonic receiving probe includes a plurality of ultrasonic probes aligned vertically.

15. The apparatus for producing hydrogen by an IS process according to claim 12, wherein the ultrasonic receiving probe includes an ultrasonic probe movable along a vertical direction.
